(19) United States
(12) Patent Application Publication
(10) Pub. No.: US 2011/0134361 A1
(43) Pub. Date: Jun. 9, 2011

(54) ILLUMINATION UNIT, ILLUMINATION DEVICE, AND LIQUID CRYSTAL DISPLAY APPARATUS

(75) Inventors: Tetsuya Ueno, Osaka-shi (JP); Yukihide Kohtoku, Osaka-shi (JP)

(73) Assignee: SHARP KABUSHIKI KAISHA, Osaka-shi, Osaka (JP)

(21) Appl. No.: 13/002,770

(22) PCT Filed: Apr. 9, 2009
(86) PCT No.: PCT/JP2009/057258

§ 371 Date: Jan. 6, 2011

(30) Foreign Application Priority Data
Jul. 22, 2008 (JP) 2008-188959

(51) Int. Cl. G02F 1/13357; F21V 7/22

(52) U.S. Cl. 349/62; 362/613; 362/607

(57) ABSTRACT

An illumination unit (11) includes: a lightguide (7) having a light-emitting surface (12); and light sources (5a) and (5b) being respectively provided on a back side with respect to the light-emitting surface, the lightguide (7) including: a light-emitting section (10) whose one surface is the light-emitting surface (12); and lightguide sections (9a) and (9b) each having one end connected to the light-emitting section (10) and each having other end serving as an incident surface of light emitted from the corresponding one of the light sources (5a) and (5b), the lightguide sections (9a) and (9b) being provided on back sides with respect to a first region and a second region of the light-emitting surface (12) so as to guide the light to the second and first regions. This makes it possible to realize an illumination unit which is slim, uniform in light emission, and improved in ease of a rework process.

### TECHNICAL FIELD

The present invention relates to an illumination unit and an illumination device each of which is used as a device such as a backlight of a liquid crystal display apparatus, and to a liquid crystal display apparatus having the illumination device.

### BACKGROUND ART

Recently, liquid crystal display apparatuses rapidly diffuse in place of display apparatuses having cathode-ray tubes (CRTs). Advantages of the liquid crystal display apparatuses such as energy saving, slimness, and lightness in weight are taken so that the liquid crystal display apparatuses are widely provided to liquid crystal televisions, monitors, portable phones, etc. Enhancement of the advantages includes improvement of illumination devices (so-called backlight) each of which is provided to a back part of a liquid crystal display apparatus.

Illumination devices are broadly classified into a side light-type (also referred to as edge-light type) and a direct-type. In a side light-type illumination device, a lightguide is provided behind a liquid crystal display panel, and a light source is provided to a lateral end of the lightguide. Light emitted from the light source is reflected by the lightguide so that the liquid crystal display panel is irradiated with the light indirectly and uniformly. Such a structure makes it possible to realize slimming down and a high uniformity of luminances of an illumination device, although the luminances are low. For this reason, side light-type illumination devices are mainly adopted in small or medium-sized liquid crystal displays such as those of portable phones and notebook PCs.

Examples of the direct-type illumination devices encompass one disclosed in Patent Literature 1. Patent Literature 1 discloses a surface light source device which is arranged such that a thickened portion is provided in an approximate center of a light-emitting surface, and a light-emitting element provided to the thickened portion emits light so that a uniform light is emitted from the light-emitting surface in a surface-emitting manner.

A further slimming down of a large liquid crystal display can be realized by reducing a distance between the light source and the liquid crystal display panel. In this case, however, uniformity of luminance of the illumination device cannot be obtained without many light sources. On the other hand, the more light sources, the higher the costs. Therefore, hoped is the development of an illumination device which does not have many light sources but is slim and excellent in uniformity of luminance.

In order that the problems may be solved, an attempt is heretofore made to slim down a large liquid crystal display by arranging a plurality of side light-type illumination devices.

As illustrated in FIG. 6, for example, a surface light source device disclosed in Patent Literature 2 has introduction sections 114a to 114c which are separate illumination devices. The introduction section 114a is arranged such that a rod-like light source 111a is surrounded by a reflecting member 112a on one lateral side, the upper side, and the lower side, and a light guide plate 113a is provided on the other lateral side so as to have a tapered cross-section. The introduction sections 114b to 114c are also arranged in this way. Tip portions of the light guide plates 113a and 113b overlap the adjacent introduction sections 114b and 114c, respectively. Since this structure makes it possible to obtain further uniform luminance in a large area, the structure is suitably applicable to a large liquid crystal display.

Such an illumination device in which a plurality of light-emitting units are arranged each of which is a combination of a light source and a lightguide plate is referred to as tandem-type illumination device.

### Citation List

Patent Literature 1

Japanese Patent Application Publication, Tokukai, No. 2007-155791 A (Publication Date: Jun. 21, 2007)

Patent Literature 2

Japanese Patent Application Publication, Tokukai, No. 2001-312916 A (Publication Date: Nov. 9, 2001)

### SUMMARY OF INVENTION

### Technical Problem

In a case where a surface light source device is made up of a plurality of light-emitting units as is the case with the aforementioned tandem-type illumination device, various members provided below the light-emitting units and/or lightguides can have failures such as that damage of a light-emitting diode (LED) to be used as a light source which is caused in a manufacturing step. A rework process for replacing light-emitting units is preformed in order that such a failure caused in a manufacturing step may be removed.

However, the surface light source device disclosed in Patent Literature 2 takes a laminated structure in which two adjacent light-emitting units overlap each other. Therefore, even if a failure of one light-emitting unit is found after the light-emitting units are combined, it is impossible to remove only the light-emitting unit having the failure. That is, it is necessary to remove an adjacent light-emitting unit overlapping the light-emitting unit having the failure.

Thus, the surface light source device disclosed in Patent Literature 2 does not allow removal of only a light-emitting unit having a failure. This makes the rework process troublesome.

The present invention was made in view of the problem. An object of the present invention is to provide an illumination unit, an illumination device, and a liquid crystal display apparatus which are slim, uniform in light emission, and improved in ease of a rework process.

### Solution to Problem

In order to attain the object, an illumination unit of the present invention is an illumination unit for use as a backlight of a transmissive display panel, including: a lightguide having a light-emitting surface; and a first light source and a second light source, respectively being provided on a back side with respect to the light-emitting surface, the lightguide including: a common section whose one surface is the light-emitting surface; and each of a first lightguide section and a second lightguide section whose one end is connected to the common section and whose other end serves as an incident surface of light emitted from the corresponding one of the first light source and the second light source, the first lightguide section and the second lightguide section being respectively provided on respective back sides with respect to a first region and a second region of the light-emitting surface and formed so as to guide the light to the second region and the first region of the light-emitting surface, respectively.

According to the arrangement, most of the light from the first and second light sources does not directly travel to the light-emitting surface of the common section, but is repeatedly reflected in the first and second lightguide sections while being guided to the common section, so as to be emitted from the light-emitting surface in the surface-emitting manner.

This further uniformalize an intensity of the light to be emitted from the light-emitting surface. Therefore, even if, e.g., each of the first and second light sources is made up of a plurality of light sources of respective different types corresponding respectively to different emission colors, rays of light which have respective different colors are sufficiently mixed so as to be emitted from the light-emitting surface.

It is necessary to secure a certain distance in each of the first and second lightguide sections along their light-guiding directions, for an effective uniformalization, and in addition, for sufficient color mixture in the case of, e.g., the first and second light sources each made up of a plurality of light sources of respective different types corresponding respectively to different emission colors. In the conventional tandem-type illumination device, adjacent lightguides are disposed so as to overlap each other, in order that such a distance may be secured. However, in a case where a rework (repair) process is performed on an illumination unit of the conventional tandem-type illumination device so that a lightguide having a failure and/or a light source having a failure is removed, it is necessary to remove even a nondefective lightguide disposed so as to overlap the lightguide having a failure.

According to the aforementioned arrangement of the present invention, in contrast, the first lightguide section is provided on the back side with respect to the first region of the light-emitting surface so as to guide light to the second region, and similarly, the second lightguide section is provided on the back side with respect to the second region of the light-emitting surface so as to guide light to the first region. The first and second regions correspond to two areas into which the light-emitting surface is virtually divided, respectively. According to the arrangement, the light from the first light source and the light from the second light source intersect with each other on the back side with respect to the light-emitting surface, so as to be guided to different areas.

The arrangement makes it possible to dispose the first and second lightguide sections and the first and second light sources almost or completely within the light-emitting surface in planer view. In addition, the arrangement makes it possible to secure a sufficient distance in each of the first and second lightguide sections along their light guiding directions (i.e., along the traveling directions of light emitted from the first and second light sources).

This makes it possible to adjacently dispose a plurality of illumination units so that any adjacent lightguides thereof do not overlap each other. In other words, it is possible to prevent such adjacent lightguides from interfering with each other in a rework process.

In a case where a specific lightguide has a failure after the illumination device is assembled from the plurality of illumination units, this makes it possible to replace only an illumination unit having the failure with a nondefective one in a rework process for replacing, with a nondefective one, an illumination unit having a failure. This makes it possible to carry out the rework process more efficiently, as compared to a tandem-type illumination device.

Therefore, the arrangement makes it possible to obtain the same effect as the tandem structure, and also increase ease of the rework process.

In other words, the arrangement makes it possible to realize an illumination device which is slim, uniform in its light emission, and improved in ease of a rework process.

The illumination unit of the present invention is preferably arranged such that each of the first lightguide section and the second lightguide section is disposed so that its light guiding direction is inclined with respect to the light-emitting surface.

According to the arrangement, the light from the first and second light sources uniformly reaches the light-emitting surface. This makes it possible to provide an illumination unit which emits, in the surface-emitting manner, light which is uniform in light amount.

The illumination unit of the present invention is preferably arranged such that each of the first lightguide section and the second lightguide section is disposed so that its light guiding direction is parallel with the light-emitting surface.

This makes it possible to further reduce a thickness of each of the first and second lightguides. This realizes slimming down of the illumination unit.

The illumination unit of the present invention is preferably arranged such that: each of the first lightguide section and the second lightguide section includes a light guiding direction changing section at a boundary between the lightguide section and the common section, the light guiding direction changing section changing the light guiding direction of the lightguide section.

According to the arrangement, a light guiding direction of the light emitted from the first light source is changed by the corresponding light guiding direction changing section so that the light travels to the light-emitting surface. Similarly, a light guiding direction of the light emitted from the second light source is changed by the corresponding light guiding direction changing section so that the light travels to the light-emitting surface.

The illumination unit of the present invention preferably includes a plurality of light diffusing means for diffusing light, the plurality of light diffusing means being provided on the light-emitting surface or on an opposite surface of the common section wherein the opposite surface is an opposite side of the light-emitting surface, the plurality of light diffusing means being disposed with a distribution density that is varied on the basis of an amount of light emission from the light-emitting surface.

Even if an in-plane distribution of amount of light to be emitted from the light-emitting surface is nonuniform, the light diffusing means makes it possible to uniformalize the in-plane distribution. This makes it possible to provide an illumination unit which emits light more uniformly in the surface-emitting manner.

The illumination unit of the present invention is preferably arranged such that: the common section has a first opposite surface and a second opposite surface wherein the first opposite surface and second opposite surface are opposite sides of the first region and the second region, respectively, the first opposite surface is formed with an inclination so that a distance between the first opposite surface and the light-emitting surface decreases with an increasing distance from the second light source, and the second opposite surface is formed with an inclination so that a distance between the second opposite surface and the light-emitting surface decreases with an increasing distance from the first light source.

The light emitted from the first light source is reflected by the second opposite surface, and similarly, the light emitted from the second light source is reflected by the first opposite surface. Thus, the light is uniformly reflected by the first and second opposite surfaces toward the light-emitting surface. This makes it possible to provide an illumination unit which performs further uniform surface light emission.

The illumination unit of the present invention is preferably arranged such that: the first light source and the second light source are point light sources, each of which is provided in a midpoint of width of the corresponding one of the first lightguide section and the second lightguide section, where the width of each of the first lightguide section and the second lightguide section is a dimension perpendicular to a length thereof along a light traveling direction from the first light source or the second light source to the common section, each of the first lightguide section and the second lightguide section satisfies the following formula:

$$X \geq \frac{L 1 \times n \sqrt{\{ 1 - ( 1 / {n}^{2} ) \}}}{2} \qquad [ Formula 1 ]$$

where: X is a distance, along the length of the corresponding one of the first lightguide section and the second lightguide section, between the corresponding one of the first light source and the second light source and the common section; L1 is a width dimension of the lightguide; and n is a refractive index of the lightguide.

According to the arrangement, a lower limit of the distance X is such a distance that on a boundary surface between the light-emitting section and the first lightguide section, light entering from the first light source to the lightguide at a critical angle is expanded to both ends of the first lightguide section which both ends are located along the width direction of the first lightguide section, and similarly, on a boundary surface between the light-emitting section and the second lightguide section, light entering from the second light source to the lightguide at the critical angle is expanded to both ends of the second lightguide section which both ends are located along the width direction of the second lightguide section. This makes it possible to expand, over the entire boundary surface between the common section and the first lightguide section, the light entering from the first light source to the first lightguide section at the critical angle. Similarly, this makes it possible to expand, over the entire boundary surface between the common section and the second lightguide section, the light entering from the second light source to the second lightguide section at the critical angle. The critical angle is determined depending on a refractive index of each of the first and second lightguide sections.

The illumination of the present invention is preferably arranged such that: each of the first light source and the second light source is a group of point light sources in which group a plurality of point light sources of respective different types corresponding respectively to different emission colors are arranged along width of the corresponding one of the first lightguide section and the second lightguide section, where the width of each of the first lightguide section and the second lightguide section is a dimension perpendicular to a length thereof along a light traveling direction from the first light source or the second light source to the corresponding light-emitting section; each of the first light source and the second light source is provided at a center of a length L1; and each of the first lightguide section and the second lightguide section satisfies the following formula:

$$X \geq \frac{( L 1 + L 2 ) n \sqrt{\{ 1 - ( 1 / {n}^{2} ) \}}}{2} \qquad [ Formula 2 ]$$

where: X is a distance, along the length of the corresponding one of the first lightguide section and the second lightguide section, between the corresponding one of the first light source and the second light source and the common section; L2 is a distance between a rightmost one of the plurality of point light sources and a leftmost one of the plurality of point light sources; L1 is a width dimension of the lightguide; and n is a refractive index of the lightguide.

According to the arrangement, for each of the first and second lightguide sections, a lower limit of the distance X is such a distance that light entered at the critical angle into the lightguide from a light source which is farthest from one end of the lightguide reaches the one end. This makes it possible to expand, over the entire boundary surface between the common section and the first lightguide section, the light entered at the critical angle into the lightguide from each of the plurality of light sources. Similarly, this makes it possible to expand, over the entire boundary surface between the common section and the second lightguide section, the light entered at the critical angle into the lightguide from each of the plurality of light sources. The critical angle is determined depending on a refractive index of each of the first and second lightguide sections.

Further, in a case where the plurality of light sources are, e.g., light-emitting diodes of respective different colors such as red (R), green (G), and blue (B), the arrangement makes it possible to prevent rays of light which have respective different colors from reaching the common section before the rays of light is uniformly mixed. This makes it possible to uniformly mix the rays of light which have respective different colors, on the boundary surface between the common section and the first lightguide section and on the boundary surface between the common section and the second lightguide section.

Therefore, the arrangement allows the light-emitting surfaces to emit further uniform light in a case where the plurality of light sources are those of different types having respective different emission colors.

The illumination unit of the present invention preferably includes a plurality of such illumination units, the plurality of illumination units being planarly disposed.

The arrangement makes it possible to provide an illumination device improved in ease of a rework process.

An illumination device of the present invention includes the plurality of illumination units being planarly disposed, the plurality of illumination units being arrayed in such a manner that the illumination units are abutted with their adjacent illumination units at their portions at which the light-emitting surface and the opposite surface are closest, and spaces are formed below where the illumination units are abutted with their adjacent illumination units.

This makes it possible to provide, in the space: IC chips having certain heights such as a module and a driver; and wiring; etc. Thus, the arrangement improves flexibility of circuit design of a liquid crystal display apparatus, in designing a circuit of an illumination device, or in using the aforementioned illumination device as a backlight of the liquid crystal display apparatus.

The illumination device of the present invention is preferably arranged such that the plurality of illumination units are arrayed so that the spaces are connected with each other.

The arrangement makes it possible to convect, through the connected spaces, heat generated in the illumination device. In a case where the illumination device is provided as a backlight of a liquid crystal display apparatus, this makes it possible to convect, in the spaces, the heat generated in the liquid crystal display apparatus, so as to release the heat to the outside of the liquid crystal display apparatus. This makes it possible to realize an illumination device which can efficiently release heat generated inside a device to the outside thereof.

Further, it is preferable to provide, in the connected spaces, a member for heat release. This makes it possible to realize an illumination device which can convect the heat further efficiently.

A liquid crystal display apparatus of the present invention preferably includes, as a backlight, any one of the illumination devices.

This makes it possible to provide a liquid crystal display apparatus improved in ease of a rework process.

### Advantageous Effects of Invention

As described above, the illumination unit of the present invention includes: a lightguide having a light-emitting surface; and a first light source and a second light source, respectively being provided on a back side with respect to the light-emitting surface, the lightguide including: a common section whose one surface is the light-emitting surface; and each of a first lightguide section and a second lightguide section whose one end is connected to the common section and whose other end serves as an incident surface of light emitted from the corresponding one of the first light source and the second light source, the first lightguide section and the second lightguide section being respectively provided on respective back sides with respect to a first region and a second region of the light-emitting surface and formed so as to guide the light to the second region and the first region of the light-emitting surface, respectively.

This makes it possible to realize an illumination unit which is slim, uniform in its light emission, and improved in ease of a rework process.

### BRIEF DESCRIPTION OF DRAWINGS

FIG. 1 is a perspective view illustrating an arrangement of a light-emitting unit constituting a backlight illustrated in FIG. 2.

FIG. 2 is a schematic view illustrating an arrangement of a liquid crystal display apparatus having a backlight of the present embodiment.

FIG. 3 is a plan view illustrating a lightguide section illustrated in FIG. 2.

(a) of FIG. 4 is a plan view illustrating provision of a light diffusing measure to the light-emitting unit illustrated in FIG. 1. (b) is a side view corresponding to (a) of FIG. 4.

FIG. 5 is a side view illustrating a modification of the light-emitting unit illustrated in FIG. 1.

FIG. 6 is a schematic view illustrating a conventional tandem-type illumination device.

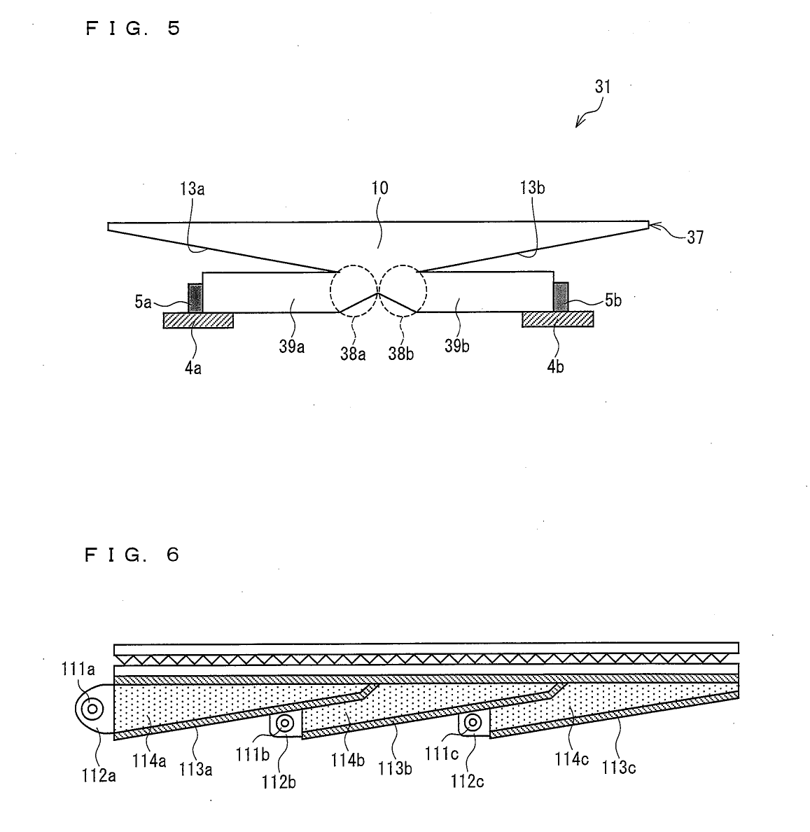

### DESCRIPTION OF EMBODIMENTS

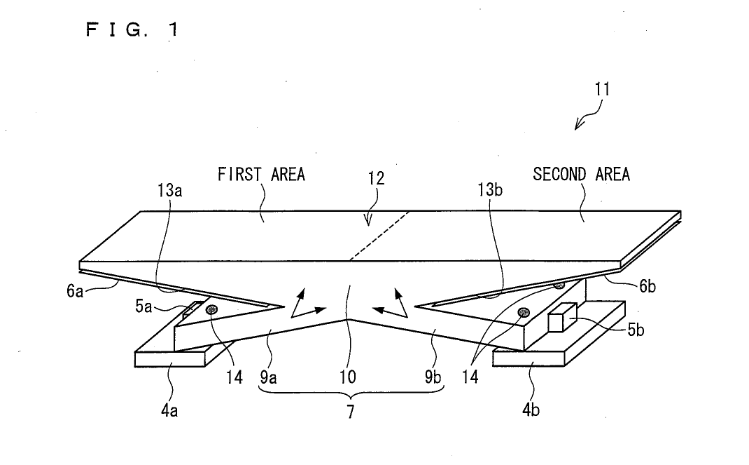

The following describes an embodiment of the present invention, with reference to FIGS. 1 to 5.

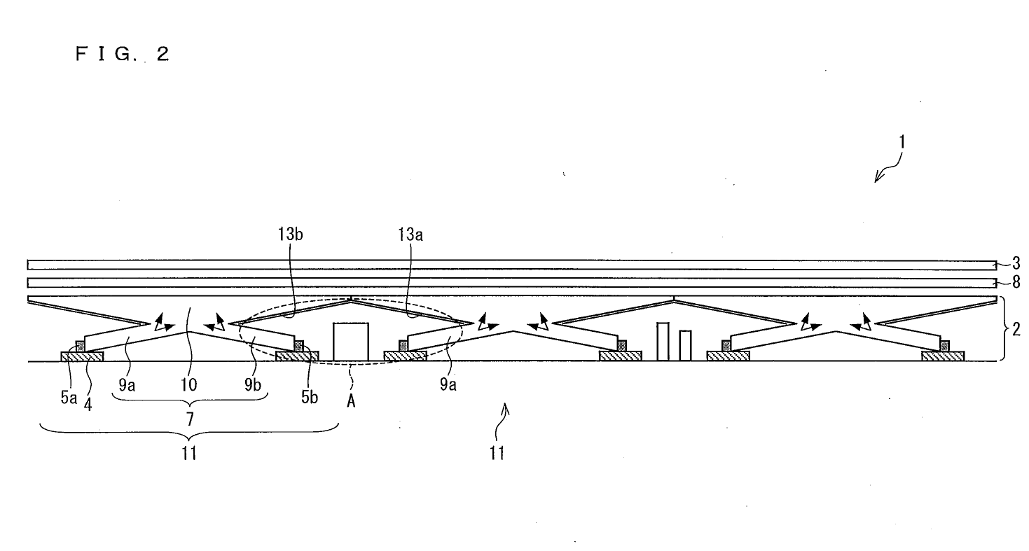

FIG. 2 is a schematic view illustrating an arrangement of that liquid crystal display apparatus of the present embodiment which has a backlight.

As illustrated in FIG. 2, a liquid crystal display apparatus 1 of the present embodiment includes: a liquid crystal display panel 3 (transmissive display panel); a backlight 2 (illumination device) provided behind the liquid crystal display panel 3; and an optical sheet 8 provided between the liquid crystal display panel 3 and the backlight 2.

The backlight 2 emits light toward the liquid crystal display panel 3 via the optical sheet 8. The liquid crystal display apparatus 1 is a transmissive liquid crystal display apparatus which displays an image by allowing the light from the backlight 2 to pass through the liquid crystal display panel 3.

An arrangement of the liquid crystal display panel 3 is not particularly limited in the present invention. Therefore, any publicly-known liquid crystal panel can be adopted as the liquid crystal display panel 3. Although the following arrangement is not illustrated, the liquid crystal display panel 3 includes: e.g., an active matrix substrate on which a plurality of TFTs (Thin Film Transistors) are formed; a color filter substrate facing the active matrix substrate; and a layer of liquid crystal sealed between the active matrix substrate and the color filter substrate by a seal material.

The following describes an arrangement of the backlight 2 provided in the liquid crystal display apparatus 1.

As illustrated in FIG. 2, the backlight 2 is provided behind the liquid crystal display panel 3 (i.e., provided on a counter side to a display surface). The backlight 2 includes a plurality of light-emitting units (illumination units) 11. Each of the light-emitting units 11 is realized by combining light sources 5a and 5b with a lightguide 7. The light-emitting units 11 are provided on a substrate (not illustrated) for a liquid crystal display apparatus.

The following describes details of the arrangement of a light-emitting unit 11, with reference to FIG. 1.

FIG. 1 is a perspective view illustrating an arrangement of a light-emitting unit 11 of the present embodiment.

One light-emitting unit 11 includes: light sources 5a (first light source) and 5b (second light source); a lightguide 7 for diffusing light from the light sources 5a and 5b and emitting the light in the surface-emitting manner; bases 4a and 4b on which the light sources 5a and 5b are provided; reflecting sheets 6a and 6b; etc.

Each of the light sources 5a and 5b is provided on the back side with respect to the light-emitting surface 12. Each of the light sources 5a and 5b is a point-like light source such as a light-emitting diode (LED). According to the present embodiment, each of the light sources 5a and 5b is made up of light-emitting diodes of different types having respective different emission colors. Specifically, each of the light sources 5a and 5b is a group of LEDs in which group at least three light-emitting diodes corresponding respectively to the three colors: red (R); green (G); and blue (B) are arranged. Thus, each of the light sources 5a and 5b is realized by combining the light-emitting diodes of the three colors. This allows the light-emitting surfaces 11a and 11b to emit white light.

How colors of light-emitting diodes are combined can be determined on the basis of chromogenic characteristics of light-emitting diodes of respective different colors and that chromogenic characteristic of the backlight 2 of the liquid crystal display apparatus 1 which is required as to a purpose of use thereof. The light sources 5a and 5b are mounted on the bases 4a and 4b, respectively. Instead of such light-emitting diodes, a side-light-type LED can be adopted as each of the light sources 5a and 5b. The side-light-type LED is made by molding LED chips of respective different colors into one package. This makes it possible to obtain a backlight having a wide color reproduction range. Alternatively, each of the light sources 5a and 5b can be realized by one light-emitting diode of white so as to emit white light.

The lightguide 7 is for guiding the light emitted from the light sources 5a and 5b to the light-emitting surface (also referred to as light exit plane) 12 so that the light is emitted from the light-emitting surface 12 in the surface-emitting manner. The light-emitting surface 12 is a surface for irradiating, with light, the liquid crystal display panel 3 which is a subject to be irradiated.

In the present embodiment, the lightguide 7 includes: a light-emitting section 10 (common section); a lightguide section 9a (first lightguide section) for guiding light from the light source 5a to the light-emitting section 10; and a lightguide section 9b (second lightguide section) for guiding light from the light source 5b to the light-emitting section 10.

The light-emitting surface 12 is for emitting, in the surface-emitting manner, the light from each of the light sources 5a and 5b.

The lightguide sections 9a and 9b are provided on the back side with respect to the light-emitting surface 12a. The light-emitting surface 12 is virtually divided into a first region and a second region. The lightguide section 9a is provided on the back side with respect to the first region, and similarly, the lightguide section 9b is provided on the back side with respect to the second region. The lightguide section 9a is formed so as to guide light to the second region of the light-emitting surface 12, and similarly, the lightguide section 9b is formed so as to guide light to the first region of the light-emitting surface 12. The lightguide sections 9a and 9b are disposed so that respective light guiding directions are inclined with respect to the light-emitting surface 12.

Opposite surfaces 13a and 13b are surfaces which are opposite to the light-emitting surface 12 of the light-emitting section 10. The opposite surface 13a (first opposite surface) is a surface opposite to the first region of the light-emitting surface 12, and similarly, the opposite surface 13b (second opposite surface) is a surface opposite to the second region of the light-emitting surface 12.

The opposite surface 13a is formed with an inclination so that the distance between the opposite surface 13a and the light-emitting surface 10 decreases with an increasing distance from the light source 5b. Similarly, the opposite surface 13b is formed with an inclination so that the distance between the opposite surface 13b and the light-emitting surface 12 decreases with an increasing distance from the light source 5a.

Accordingly, the light from the light source 5a and the light from the light source 5b intersect with each other on the back side with respect to the light-emitting surface 12 so as to be guided to respective different regions.

The arrangement makes it possible to dispose the lightguide sections 9a and 9b and the light sources 5a and 5b almost or completely within the light-emitting surfaces 12 in planer view. In addition, the arrangement makes it possible to secure a sufficient distance along the light guiding direction of each of the lightguide sections 9a and 9b.

This makes it possible to adjacently dispose a plurality of light-emitting units 11 so that any adjacent lightguides 7 thereof do not overlap each other. In other words, it is possible to prevent such adjacent lightguides from interfering with each other.

In a case where a specific lightguide has a failure after the backlight 2 is assembled from the plurality of light-emitting units 11, this makes it possible to replace only a light-emitting unit 11 having the failure with a nondefective one in a rework process for replacing, with a nondefective one, a light-emitting unit 11 having a failure. This makes it possible to carry out the rework process more efficiently, as compared to the case of a conventional tandem-type illumination device in which adjacent lightguides are disposed so as to overlap each other.

Therefore, the light-emitting unit 11 of the present embodiment makes it possible to realize a backlight which makes it possible to obtain the same effect as the conventional tandem structure, and also carry out the rework process efficiently. In other words, the light-emitting unit 11 makes it possible to realize the backlight 2 which is slim, uniform in its light emission, and improved in ease of a rework process.

The lightguide sections 9a and 9b are disposed so that respective light guiding directions are inclined with respect to the light-emitting surface 12. In addition, the opposite surface 13a opposite to the first region of the light-emitting surface 12 is formed so that the distance between the opposite surface 13a and the light-emitting surface 12 increases from the end of the first region which end is opposite to the border between the first and second regions toward the border. Similarly, the opposite surface 13b opposite to the second region of the light-emitting surface 12 is formed so that the distance between the opposite surface 13b and the light-emitting surface 12 increases from the end of the second region which end is opposite to the border between the first and second regions toward the border. As a result, the light-emitting surface 12 is irradiated further uniformly with the light from each of the lightguide sections 9a and 9b.

By use of fixing members 14 such as screws and pins, the lightguide section 9a is fixed to the base 4a and to a liquid crystal display apparatus driving substrate (not illustrated) etc. which are provided below the base 4a. Specifically, the lightguide section 9a is fixed thereto at two points of the lightguide section 9a near that one end of the lightguide section 9a which is closer to the light source 5a than the other end. Similarly, by use of the fixing members 14, the lightguide section 9b is fixed to the base 4b and to the liquid crystal display apparatus driving substrate (not illustrated) etc. which are provided below the base 4b. Specifically, the lightguide section 9b is fixed thereto at two points of the lightguide section 9b near that one end of the lightguide section 9b which is closer to the light source 5b than the other end.

The light (pencil of light) emitted from the light source 5a which is a point source radiates at a critical angle θ in the lightguide section 9a (to be described later in detail). Similarly, the light (pencil of light) emitted from the light source 5b which is a point light source radiates at the critical angle θ in the lightguide section 9b (to be described later in detail). Therefore, the light emitted from the light-emitting surface 12a is not affected by the fixing members 14 even though as illustrated in FIG. 1, the fixing members 14 are provided at the two points of one end portion of the lightguide section 9a which two points are located near both ends of the one end portion in the width direction of the lightguide section 9a and which one end portion is closer to the light source 5a than the other end portion. Similarly, the light emitted from the light-emitting surface 12b is not affected by the fixing members 14 even though as illustrated in FIG. 1, the fixing members 14 are provided at the two points of one end portion of the lightguide section 9b which two points are located near both ends of the one end portion in the width direction of the lightguide section 9b and which one end portion is closer to the light source 5b than the other end portion.

The surface (i.e., light-emitting surface 12) or the opposite surfaces 13a and 13b of the light-emitting section 10 of the lightguide 7 are processed and/or treated so as to emit the guided light frontward. This makes it possible to efficiently emit light from the light-emitting surface 12 toward the liquid crystal display panel 3. Examples of the processing and treatment for the surface (light-emitting surface 12) of the light-emitting section 10 of the lightguide 7 encompass prism processing, texturing, and print processing. However, processing and/or treatment for the surface is not particularly limited to this, but can be any publicly known processing and/or treatment for causing light to be emitted from a light-emitting surface.

The lightguide 7 is made from a transparent resin such as polycarbonate (PC) and polymethylmethacrylate (PMMA). However, the lightguide 7 can be made from a material which is commonly used as a material for a lightguide. The lightguide 7 can be formed by a method such as injection molding, extrusion molding, heat-press molding, and cutting. However, a method for forming the lightguide 7 is not limited to this, but can be any method, provided that the lightguide 7 can have a characteristic similar to one realized by the aforementioned methods.

The base 4a is for mounting the light source 5a thereon, and the base 4b is for mounting the light source 5b thereon. For improvement of luminance, the bases 4a and 4b are preferably while ones. Mounted on the back surface (surface opposite to the surface on which the light source 5a is mounted) of the base 4a is a driver (not illustrated) for controlling lighting of the LEDs of the light source 5a. Similarly, mounted on the back surface (surface opposite to the surface on which the light source 5b is mounted) of the base 4b is a driver (not illustrated) for controlling lighting of the LEDs of the light source 5b. Thus, the drivers are mounted on the bases 4a and 4b on which the light sources 5a and 5b are mounted. This makes it possible to reduce the number of bases, and reduce connecters or the like for connecting the bases. This realizes a low-cost device. Further, this realizes slimming down of the backlight 2 because less bases are required.

The reflection sheets 6a and 6b are provided so as to have contact with the opposite surfaces 13a and 13b, respectively. The reflecting sheets 6a and 6b are for reflecting light so that the light is efficiently emitted from the light-emitting surfaces 12a and 12b.

By providing the reflecting sheet 6a and 6b to the opposite surfaces 13a and 13b, it becomes possible to prevent a part of the light emitted from the light source 5a from not being guided to the lightguide section 9a but entering the light-emitting section 10 via the opposite surface 13a, and similarly, it becomes possible to prevent a part of the light emitted from the light source 5b from not being guided to the lightguide section 9b but entering the light-emitting section 10 via the opposite surface 13b. In other words, by providing the reflecting sheet 6a and 6b to the opposite surfaces 13a and 13b, it becomes possible to block, by the reflecting sheet 6a, the light from the light source 5a so that the light cannot enter the light-emitting section 10 via the opposite surface 13a, and to similarly block, by the reflecting sheet 6b, the light from the light source 5b so that the light cannot enter the light-emitting section 10 via the opposite surface 13b.

In the backlight 2 of the present embodiment, a plurality of light-emitting units 11 thus arranged are provided together so as to be disposed in, e.g., a matrix pattern. Specifically, an illumination area of the backlight 2 is divided into areas corresponding respectively to the plurality of light-emitting units 11.

Further, as described above, the optical sheet 8 is provided on a construction in which the plurality of light-emitting units 11 are disposed. The optical sheet 8 is realized by adopting any one of the following or by combining at least two of the following: a diffusing plate for irradiating the liquid crystal display panel 3 with uniform light; a diffusing sheet for converging and scattering light; a lens sheet for converging light so as to increase a frontward luminance; and a polarized light reflecting sheet for reflecting one polarization component and allowing the other polarization component to pass through the polarized light reflecting sheet, so as to increase a luminance of the liquid crystal display apparatus 1. How the optical sheet 8 is arranged is determined by a price and performance of the liquid crystal display apparatus 1.

According to the arrangement, the light emitted from each of the light sources 5a and 5b each of which is a point-like light source is subjected to scattering and reflection while traveling inside the lightguide 7, so as to be emitted from the light-emitting surface 12. In FIGS. 1 and 2, arrows indicate traveling directions of light.

Then, the light emitted from the light-emitting surface 12 is diffused by the optical sheet 8 provided on the frontal surfaces of the lightguide 7. Thus, the light is uniformalized and converged so that the liquid crystal display panel 3 is irradiated with the light.

A luminance of each of the plurality of light-emitting units 11 can be independently controlled. By individually controlling respective luminances of the plurality of light-emitting units 11, it becomes possible to perform area-active control of the illumination area of the backlight 2. As a result, the liquid crystal display apparatus 1 can display a high-contrast image.

(Length of Lightguide Section Along Emission Direction)

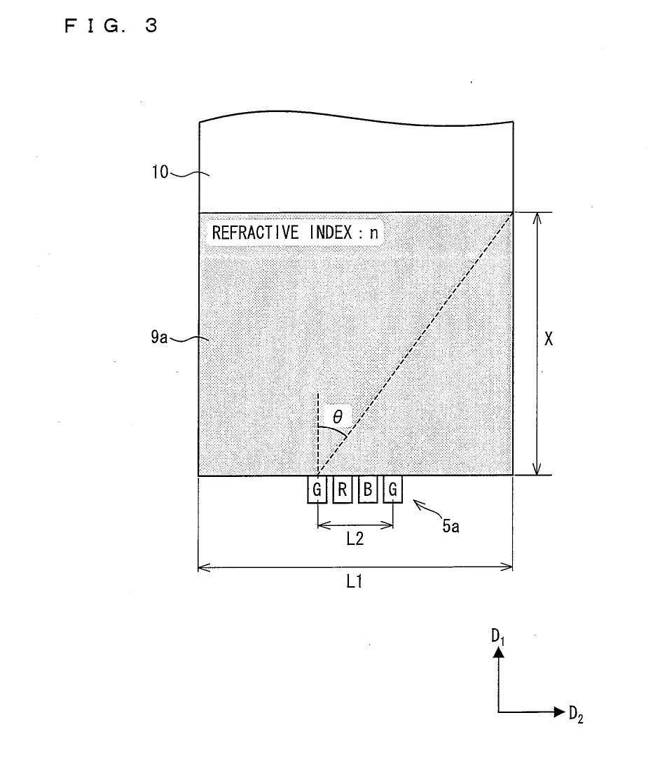

In a case where as in the case of the backlight 2 of the present embodiment, each of the light sources 5a and 5b is a group of LEDs in which group at least three light-emitting diodes corresponding respectively to the three colors: red (R), green (G), and blue (B) are arranged, the lightguide section 9a and 9b serve as color mixing areas for mixing the three colors so that white light is emitted from the light-emitting surface 12. In a case where each of the lightguide sections 9a and 9b (color mixing areas) is short in length in such a backlight 2, rays of light which respectively have the three colors are not completely mixed, but separate rays of light corresponding respectively to the three colors are emitted from each of the light-emitting surface 12. This causes luminance unevenness. The following describes the length of the lightguide sections 9a and 9b, with reference to FIG. 3. Although the following deals with the lightguide section 9a only, the same holds for the lightguide section 9b. FIG. 3 is a plan view of the lightguide section 9a.

The following example assumes that the light source 5a is a group of LEDs made up of a green LED (G-LED), a red LED (R-LED), a blue LED (B-LED), and a green LED (G-LED), and provided to the lightguide section 9a is one such light source 5a.

In FIG. 3, an emission direction of the lightguide section 9a is indicated with the direction D1, and the width direction of the lightguide section 9a is indicated with the direction D2 which width direction is perpendicular to the direction D1.

In a case where as in the case of the backlight 2 of the present embodiment, the light source 5a which is a point-like light source and the lightguide 7 are combined, a pencil of light emitted from the light source 5a radiates at a critical angle θ in the lightguide section 9a. The critical angle θ is determined by a refractive index “n” of a material from which the lightguide 7a is made. That is, the lightguide section 9a plays a role in sufficiently expanding, before the pencil of light which has entered the lightguide 7 at a critical angle θ reaches the light-emitting section 10, the pencil of light.

Assume that the refractive index of the lightguide 7 is “n.” By Snell's law, light which has entered the lightguide 7 from that airspace outside the lightguide 7 in which the light source 5a is provided has a refraction angle smaller than the critical angle θ.

In order to cause the light entering from the light source 5a to the lightguide 7 to reach the entire boundary surface between the light-emitting section 10 and the lightguide section 9a, it is necessary that the light entering from the light source 5a to the lightguide 7 at the critical angle θ reach both ends of the lightguide 7 in the lightguide section 9a which both ends are located along the width direction D2 of the lightguide 7.

A lower limit of a distance X satisfying such a condition is such a distance that light entered at the critical angle into the lightguide 7 from that one of the plurality of LEDs constituting the light source 5a which is farthest from one of the both ends of the lightguide 7 reaches the one of the both ends. In other words, the lower limit of the distance X is such a distance that light entered at the critical angle θ into the lightguide 7 from the leftmost LED in FIG. 3 (i.e., G-LED) reaches one end of the lightguide 7 on the boundary surface between the light-emitting section 10 and the lightguide section 9a, as indicated with the dashed line.

The lower limit X of the distance X satisfies the following equation (a).

tan θ={(L1+L2)/2}/X=(L1+L2)/2X (a)

By Snell's law, the following equation (b) can be obtained.

sin θ=1/n (b)

Further, the following equation (c) can be obtained from a formula of a trigonometric function.

$$\begin{matrix}[ Formula 3 ] & \\ tan θ = \frac{sin θ}{\sqrt{( 1 - {sin}^{2} θ )}} & ( c )\end{matrix}$$

The lower limit of the distance X satisfies the following equation (d) which is obtained from the equations (a) to (c).

$$\begin{matrix}[ Formula 4 ] & \\ ( L 1 + L 2 ) / 2 X = \frac{1}{n \sqrt{\{ 1 - 1 ( 1 / {n}^{2} ) \}}} \\ X = \frac{( L 1 + L 2 ) n \sqrt{\{ 1 - ( 1 / {n}^{2} ) \}}}{2} & ( d )\end{matrix}$$

Therefore, the distance X preferably satisfies the following equation (1).

$$\begin{matrix}[ Formula 5 ] & \\ X \geq \frac{( L 1 + L 2 ) n \sqrt{\{ 1 - ( 1 / {n}^{2} ) \}}}{2} & ( 1 )\end{matrix}$$

In a case where the following equation (1) is satisfied, each of the light sources 5a and 5b is located in the midpoint of that length L1 of each of the lightguides 7 which is parallel with the width direction D2 of the lightguide 7. This makes it possible to set the distance X of the lightguide section 9a to a smaller value, as compared to an arrangement in which each of the light sources 5a and 5b is located, along the width direction D2, closer to either end of the lightguide 7.

The backlight 2 which is made by combining the light-emitting units 11 makes it possible to expand, over the entire boundary surface between the light-emitting section and the lightguide section, light emitted at the critical angle from each of the plurality of light sources into a corresponding one of the lightguides. Further, in a case where each of the light sources is made up of light-emitting diodes of respective different colors, the backlight 2 makes it possible to prevent rays of light which have respective different colors from reaching the light-emitting section before the rays of light is uniformly mixed. This makes it possible to uniformly mix the rays of light which have respective different colors, on the boundary surface between the light-emitting section and the lightguide section.

In a case where the light source 5a is realized by one white LED, L2=0 is satisfied. Therefore, it is preferable to satisfy the following equation (2).

$$\begin{matrix}[ Formula 6 ] & \\ X \geq \frac{L 1 \times n \sqrt{\{ 1 - ( 1 / {n}^{2} ) \}}}{2} & ( 2 )\end{matrix}$$

As illustrated in FIG. 2, in the backlight 2 of the present embodiment, a plurality of light-emitting units 11 are planarly disposed. The plurality of light-emitting units 11 are arrayed in a line so that any two adjacent light-emitting units 11 are abutted with each other at their respective portions at one of which the light-emitting surface 12 and the opposite surface 13a are closest and at the other one of which the light-emitting surface 12 and the opposite surface 13b are closest.

Specifically, the light-emitting units 11 are arrayed in a line in such a manner that any two adjacent light-emitting units 11 are abutted with each other at their respective portions at one of which a distance between the light-emitting surfaces 12 and the opposite surface 13a is shortest and at the other one of which a distance between the light-emitting surfaces 12 and the opposite surface 13b is shortest.

A space A is formed, between two adjacent light-emitting units 11, below such ends thereof.

The space A is a space surrounded by: the opposite surface 13b of the light-emitting section 10 of one lightguide 7; the lightguide section 9a; the opposite surface 13a of the light-emitting section 10 of an adjacent lightguide 7; and the lightguide section 9b. The space A makes it possible to provide therein: a driver; a module; an IC chip having a certain height; wiring; etc. each used for driving the liquid crystal display apparatus 1. Concrete examples encompass a thermistor for temperature measurement, a photosensor for measuring the degree of deterioration of an LED, and a driver for driving LEDs which driver can control lighting of the plurality of LEDs of each of the light sources 5a and 5b.

Thus, the space A is formed according to the arrangement of the backlight 2 of the present embodiment. This improves flexibility of circuit design of the liquid crystal display apparatus 1.

Further, the plurality of light-emitting units 11 can be arrayed so that the spaces A are connected with each other.

Specifically, the plurality of light-emitting units 11 are disposed so that the spaces A are connected with each other from the top to the bottom (or from the right to the left) of the liquid crystal display apparatus 1 in use thereof. This makes it possible to convect, in the spaces A, the heat generated from the backlight 2 and the heat generated from the circuit of the liquid crystal display apparatus 1, so as to release the heat to the outside of the liquid crystal display apparatus 1.

Further, by providing, in each of the spaces A, a member for heat release such as a heat pipe, it becomes possible to release the heat generated from the circuit of the liquid crystal display apparatus 1 to the outside thereof via the spaces A further efficiently. Thus, the arrangement of the backlight 2 of the present embodiment makes it possible to efficiently release such heat to the outside of the liquid crystal display apparatus 1.

(Disposition of Light-Diffusing Measure)

The backlight 2 of the present embodiment can have a plurality of prisms 15 (light-diffusing measure) for diffusing light, on each of the light-emitting surface 12 (i.e., surface on the liquid crystal display panel 3 side) or the opposite surfaces 13a and 13b.

The following describes this, with reference to (a) and (b) of FIG. 4.

(a) of FIG. 4 is a plan view illustrating a light-emitting unit of the present embodiment. (b) of FIG. 4 is a side view corresponding to (a) of FIG. 4.

As illustrated in (a) and (b) of FIG. 4, the light-emitting unit 21 is arranged such that a plurality of prisms are disposed on the light-emitting surface 12 as a light-diffusing measure. Except for this, the light-emitting unit 21 is arranged in the same way as the light-emitting unit 11.

For example, as illustrated in (a) and (b) of FIG. 4, the prisms 15 are disposed on the light-emitting surface 12 so that a distribution density of the prisms 15 varies from dense to sparse as a distance from the center of the light-emitting surface 12 decreases.

Thus, the prisms 15 are disposed so as to be high in distribution density in an area on the light-emitting surface 12 where a small amount of light is emitted in the surface-emitting manner. In contrast, the prisms 15 are disposed so as to be low in distribution density in an area on the light-emitting surface 12 where a large amount of light is emitted in the surface-emitting manner. Thus, the plurality of prisms 15 are disposed on the light-emitting surface 12 so that an in-plane distribution of amounts of light emitted from the light-emitting surface 12 in the surface-emitting manner becomes uniform.

A distribution density of the prisms 15 is determined on the basis of an amount of light emission from the light-emitting surface 12 of the lightguide 7. Therefore, how the prisms 15 are disposed is not particularly limited. Thus, the prisms 15 are provided on the light-emitting surface 12 as a light-diffusing measure. This makes it possible to further increase uniformity of luminance of the backlight 2.

The light-diffusing measure is not limited to a prism. It is possible to adopt those which are conventionally adopted as a light-diffusing member of an illumination device, such as minute projections and depressions (grain pattern or the like), and a printed dot pattern.

(Modification)

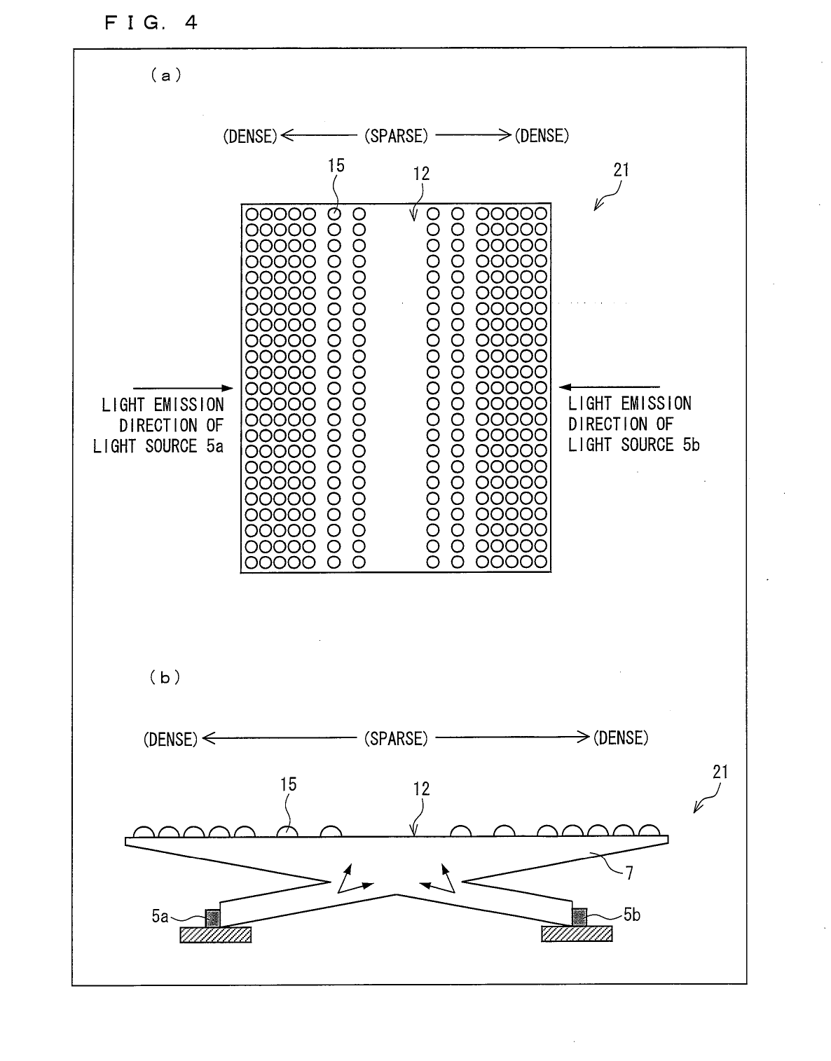

The following describes a modification of the light-emitting unit 11, with reference to FIG. 5.

FIG. 5 is a side view illustrating the modification of the light-emitting unit 11 of the present embodiment.

The light-emitting unit 31 is different from the light-emitting unit 11 in contact angle between the light-emitting section and the lightguide section.

As illustrated in FIG. 5, a lightguide 37 includes a light-emitting section 10 (light-emitting section) having a light-emitting surface 12, a lightguide section 39a (first lightguide section) for guiding light from a light source 5a to the light-emitting section 10, and a lightguide section 39b (second lightguide section) for guiding light from a light source 5b to the light-emitting section 10.

The light-emitting section 10 has the same shape as that of the light-emitting unit 11.

The lightguide sections 39a and 39b includes connecting areas 38a and 38b (light-guiding direction changing sections), respectively. The lightguide sections 39a and 39b are disposed so that their light guiding directions are parallel with the light-emitting surface 12. The connecting area 38a is provided in the vicinity of the boundary between the lightguide section 39a and the light-emitting section 10. Similarly, the connecting area 38b is provided in the vicinity of the boundary between the lightguide section 39b and the light-emitting section 10. A bottom surface of the connecting area 38a is disposed so that an end of the bottom surface which end has contact with the connecting area 38b is inclined toward the light-emitting surface 12. The same holds for the bottom surface of the connecting area 38b.

Thus, the light guiding directions of the lightguide sections 39a and 39b are set parallel with the light-emitting surface 12. The light-emitting unit 31 can have a smaller thickness, as compared to the light-emitting unit 11. This makes it possible to realize a small thickness of the backlight 2. This realizes slimming down of the liquid crystal display apparatus 1.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention makes it possible to provide an illumination device whose light source uniformly emits light and which is improved in ease of a rework process. The illumination device of the present invention can be used as a backlight of a liquid crystal display apparatus.

### REFERENCE SIGNS LIST

1 Liquid crystal display apparatus
2 Backlight (illumination device)
3 Liquid crystal display panel (transmissive display panel)
4a and 4b Base
5a Light source (first light source)
5b Light source (second light source)
6a and 6b Reflecting sheet
7 Lightguide
8 Optical sheet
9a Lightguide section (first lightguide section)
9b Lightguide section (second lightguide section)
10 Light-emitting section (common section)
11 Light-emitting unit (illumination unit)
12 Light-emitting surface
13a Opposite surface (first opposite surface)
13b Opposite surface (second opposite surface)
14 Fixing member
15 Prism (light-diffusing measure)
21 Light-emitting unit (illumination unit)
31 Light-emitting unit (illumination unit)
37 Lightguide
38a and 38b Connecting area (light-guiding direction changing section)
39a Lightguide section (first lightguide section)
39b Lightguide section (second lightguide section)

1. An illumination unit for use as a backlight of a transmissive display panel, comprising:
a lightguide having a light-emitting surface; and
a first light source and a second light source, respectively being provided on a back side with respect to the light-emitting surface,
the lightguide including:
a common section whose one surface is the light-emitting surface; and
each of a first lightguide section and a second lightguide section whose one end is connected to the common section and whose other end serves as an incident surface of light emitted from the corresponding one of the first light source and the second light source,
the first lightguide section and the second lightguide section being respectively provided on respective back sides with respect to a first region and a second region of the light-emitting surface and formed so as to guide the light to the second region and the first region of the light-emitting surface, respectively.

2. The illumination unit as set forth in claim 1, wherein:
each of the first lightguide section and the second lightguide section is disposed so that its light guiding direction is inclined with respect to the light-emitting surface.

3. The illumination unit as set forth in claim 1, wherein:
each of the first lightguide section and the second lightguide section is disposed so that its light guiding direction is parallel with the light-emitting surface.

4. The illumination unit as set forth in claim 3, wherein:
each of the first lightguide section and the second lightguide section includes a light guiding direction changing section at a boundary between the lightguide section and the common section, the light guiding direction changing section changing the light guiding direction of the lightguide section.

5. The illumination unit as set forth in claim 1, comprising:
a plurality of light diffusing means for diffusing light, the plurality of light diffusing means being provided on the light-emitting surface or on an opposite surface of the common section wherein the opposite surface is an opposite side of the light-emitting surface,
the plurality of light diffusing means being disposed with a distribution density that is varied on the basis of an amount of light emission from the light-emitting surface.

6. The illumination unit as set forth in claim 1, wherein:
the common section has a first opposite surface and a second opposite surface wherein the first opposite surface and second opposite surface are opposite sides of the first region and the second region, respectively,
the first opposite surface is formed with an inclination so that a distance between the first opposite surface and the light-emitting surface decreases with an increasing distance from the second light source, and
the second opposite surface is formed with an inclination so that a distance between the second opposite surface and the light-emitting surface decreases with an increasing distance from the first light source.

7. The illumination unit as set forth in claim 1, wherein:
the first light source and the second light source are point light sources, each of which is provided in a midpoint of width of the corresponding one of the first lightguide section and the second lightguide section, where the width of each of the first lightguide section and the second lightguide section is a dimension perpendicular to a length thereof along a light traveling direction from the first light source or the second light source to the common section,
each of the first lightguide section and the second lightguide section satisfies the following formula:
$$X \geq \frac{L 1 \times n \sqrt{\{ 1 - ( 1 / {n}^{2} ) \}}}{2} \qquad [ Formula 1 ]$$
where:
X is a distance, along the length of the corresponding one of the first lightguide section and the second lightguide section, between the corresponding one of the first light source and the second light source and the common section;
L1 is a width dimension of the lightguide; and
n is a refractive index of the lightguide.

8. The illumination unit as set forth in claim 1, wherein:
each of the first light source and the second light source is a group of point light sources in which group a plurality of point light sources of respective different types corresponding respectively to different emission colors are arranged along width of the corresponding one of the first lightguide section and the second lightguide section, where the width of each of the first lightguide section and the second lightguide section is a dimension perpendicular to a length thereof along a light traveling direction from the first light source or the second light source to the corresponding light-emitting section;
each of the first light source and the second light source is provided at a center of a length L1; and
each of the first lightguide section and the second lightguide section satisfies the following formula:
$$X \geq \frac{( L 1 + L 2 ) n \sqrt{\{ 1 - ( 1 / {n}^{2} ) \}}}{2} \qquad [ Formula 2 ]$$
where:
X is a distance, along the length of the corresponding one of the first lightguide section and the second lightguide section, between the corresponding one of the first light source and the second light source and the common section;
L2 is a distance between a rightmost one of the plurality of point light sources and a leftmost one of the plurality of point light sources;
L1 is a width dimension of the lightguide; and
n is a refractive index of the lightguide.

9. An illumination device comprising a plurality of illumination units each recited in claim 1, the plurality of illumination units being planarly disposed.

10. An illumination device comprising a plurality of illumination units each recited in claim 6, the plurality of illumination units being planarly disposed,
the plurality of illumination units being arrayed in such a manner that the illumination units are abutted with their adjacent illumination units at their portions at which the light-emitting surface and the opposite surface are closest, and spaces are formed below where the illumination units are abutted with their adjacent illumination units.

11. The illumination device as set forth in claim 10, wherein the plurality of illumination units are arrayed so that the spaces are connected with each other.

12. A liquid crystal display apparatus comprising, as a backlight, an illumination device recited in claim 9.
